(19) United States
(12) Patent Application Publication
(10) Pub. No.: US 2018/0302235 A1
(43) Pub. Date: Oct. 18, 2018

(54) MODULAR ASSEMBLY DEVICE CONTROLLER

(71) Applicant: SmartLabs, Inc., Irvine, CA (US)

(72) Inventors: Daniel Brian Cregg, Costa Mesa, CA (US); Sergio Isaac Sanz, Orange, CA (US)

(21) Appl. No.: 15/953,724

(22) Filed: Apr. 16, 2018

Related U.S. Application Data
(60) Provisional application No. 62/486,083, filed on Apr. 17, 2017.

(51) Int. Cl. H04L 12/28; H04B 3/54

(52) U.S. Cl. CPC H04L 12/282; H04L 2012/2843; H04L 2012/2841; H04B 3/54

(57) ABSTRACT

A modular assembly device controller comprises a user interface module, a load control module, and a mounting bracket. The user interface module receives user input and is easily interchangeable to suit the needs of the user. The user interface module can include one or more switches, control knobs, or other actuation devices, as well as feedback devices configured to provide the user with visual and/or audible indications. The load control module includes load control circuitry, a power supply, and a local receiver that is located within a home network employing a powerline communication protocol, and an RF communication protocol.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Residential wiring is installed during the construction phase of home building according to the building codes. The electrical wiring connects a power source to electrical junction boxes placed throughout the house. Based on anticipated needs, some electrical junction boxes may connect to electrical devices, such as sockets, that permit direct electrical connection, such as sockets. Other electrical junction boxes may connect to electrical devices that control the access to the electrical power, such as switches. Once the wiring is installed, it is covered up during the finishing phase. Homeowners frequently find it difficult to repair, replace, or upgrade the existing electrical system because of concerns over safety. Further, most homeowners do not know the proper techniques to change home wiring.

### SUMMARY

The innovations described in the claims each have several aspects, no single one of which is solely responsible for the desirable attributes. Without limiting the scope of the claims, some prominent features of this disclosure will now be briefly described.

A modular load control system comprises a user interface, a load control module, and a mounting bracket. The user interface is configured to receive user input and is easily interchangeable to suit the needs of the user. In some embodiments, the user interface comprises one or more switches, control knobs, or other actuation devices. In some embodiments, the user interface comprises feedback devices configured to provide the user with visual and/or audible indications. The load control module further comprises a local receiver that is located within a network employing a powerline communication protocol and an RF communication protocol that creates a peer to peer mesh network with the ability to synchronize repeated transmissions with the other repeating devices in the network. The load control module further incorporates conversion from AC mains to logic level voltages. The load control module incorporates a low voltage interface to user interface in a safe manner, exposing logic level supply voltage, communications via serial and logic level conductors in and out of the load control module. The user interface can be simplistic logic level controls allowing simple switch level control and simple logic level indicators, or can easily be replaced with high complexity and cost user interfaces such as various high density dot matrix displays (e.g., LCD, OLED, E-Ink), motion detection, voice recognition, gesture sensing, camera, and/or various environmental sensor applications.

The network is configured to receive messages from the local receiver and pass the messages to a hub within the network which decodes the messages. The network is further configured to receive data and/or commands from the network hub and propagate the messages to the local receiver.

The user interface can receive user input from one or more of user activation of the actuation devices, commands from the hub via the powerline, and commands from the hub via RF.

The mounting bracket is in electrical communication with the house wiring and the load control module. The load control module is further in electrical communication with the user interface, and based on input received from the user interface, the load control module controls an electrical load. In an embodiment, the modular load control device controls the amount of power delivered from an AC power source to an illumination device.

In an embodiment, the network comprises a dual-band mesh area networking topology to communicate with devices located within the network. In an embodiment, the network comprises an INSTEON® network utilizing an INSTEON® engine employing a powerline protocol and an RF protocol. The devices can comprise, for example, light switches, thermostats, motion sensors, and the like. INSTEON® devices are peers, meaning each device can transmit, receive, and repeat any message of the INSTEON® protocol, without requiring a master controller or routing software.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Certain aspects relate to an in-wall modular assembly to receive and transmit data and commands over a home network. The in-wall modular assembly comprises a mounting bracket configured to attach to an electrical box that is mounted in a house and connected to electrical power via electrical wiring. The mounting bracket is further configured to electrically connect to the electrical wiring. The in-wall modular assembly further comprises a user interface module comprising a user interface module having a user input device configured to receive user input from a user and a load control module in communication with the user interface module and configured to receive an indication of the user input from the user interface module. The user interface module is configured to be removably attached to the load control module. The mounting bracket is further configured to receive the load control module to provide the load control module with a powerline waveform from the electrical wiring. The load control module comprises receiving circuitry configured to receive coded messages over a home network using at least a first communication protocol and a second communication protocol, transmitting circuitry configured to transmit the coded messages over the home network using the at least the first and second communication protocols, where the first communication protocol is propagated over a first communication medium and the second communication protocol is propagated over a second communication medium that is different from the first communication medium, processing circuitry configured to receive the indication of the user input, to process the coded messages, and to provide control signals responsive to at least one of the indication of the user input and the coded messages, and load control circuitry configured to change an operation of a device responsive to the control signals.

The home network can be a mesh network. The first communication protocol can be powerline signaling and the second communication protocol can radio frequency (RF) signaling. The mesh network can comprise a plurality of in-wall modular assemblies, where each of the in-wall modular assemblies can be electrically coupled to the electrical wiring and configured to transmit and receive the coded messages synchronously over the mesh network using the powerline signaling and the RF signaling based on zero crossings of the powerline waveform.

The powerline signaling can comprise message data modulated onto a carrier signal and the data modulated carrier signal can be added to the powerline waveform, and the RF signaling can comprise the message data modulated onto a RF signal. The carrier signal can have a first frequency and the RF signal can have a second frequency different from the first frequency. The first frequency is approximately 131.65 kHz and the second frequency is approximately 915 MHz.

The user inputs can be received independently of the home-control network. Changing the operation of the device can comprise controlling the powerline waveform to the device. The user input module can have a configurable face. The user input device can have one or more of a toggle switch, a rocker switch, a paddle switch, a key pad, a control knob, one or more LED's, and a speaker. The device can be a lighting device and changing the operation can comprise dimming the lighting device.

Certain aspects relate to an in-home system to receive and transmit data and commands over a home network. The in-house system comprises a home network and a plurality of in-wall modular assemblies. Each in-wall modular assembly comprises a mounting bracket configured to attach to an electrical box that is mounted in a house and connected to electrical power via electrical wiring. The mounting bracket is further configured to electrically connect to the electrical wiring. Each in-wall modular assembly further comprises a user interface module comprising a user interface module having a user input device configured to receive user input from a user and a load control module in communication with the user interface module and configured to receive an indication of the user input from the user interface module. The user interface module is configured to be removably attached to the load control module. The mounting bracket is further configured to receive the load control module to provide the load control module with a powerline waveform from the electrical wiring. The load control module comprises receiving circuitry configured to receive coded messages over a home network using at least a first communication protocol and a second communication protocol, transmitting circuitry configured to transmit the coded messages over the home network using the at least the first and second communication protocols, where the first communication protocol is propagated over a first communication medium and the second communication protocol is propagated over a second communication medium that is different from the first communication medium, processing circuitry configured to receive the indication of the user input, to process the coded messages, and to provide control signals responsive to at least one of the indication of the user input and the coded messages, and load control circuitry configured to change an operation of a device responsive to the control signals.

The first communication protocol can be powerline signaling that can comprise message data modulated onto a carrier signal and the data modulated carrier signal is added to the powerline waveform, and the second communication protocol can be radio frequency signaling that comprises the message data modulated onto a RF signal. The home network can be a mesh network and each of the in-wall modular assemblies can be electrically coupled to the electrical wiring and configured to transmit and receive the coded messages synchronously over the mesh network using the powerline signaling and the RF signaling based on zero crossings of the powerline waveform.

Certain embodiments relate to a method to receive and transmit data and commands over a home network. The method comprises receiving with a mounting bracket, electrical power via electrical wiring from an electrical box that is mounted in a house; receiving with a user interface module, user input from a user; receiving with a load control module an indication of the user input from the user interface module, where the user interface module is configured to be removably attached to and in communication with the load control module; receiving with the load control module a powerline waveform from the electrical wiring, where the mounting bracket is configured to be attached to and in communication with the load control module; receiving with receiving circuitry of the load control module coded messages over a home network using at least a first communication protocol and a second communication protocol; transmitting with transmitting circuitry of the load control module the coded messages over the home network using the at least the first and second communication protocols, where the first communication protocol is propagated over a first communication medium and the second communication protocol is propagated over a second communication medium that is different from the first communication medium; receiving with processing circuitry of the load control module the indication of the user input, to process the coded messages; providing with the processing circuitry control signals responsive to at least one of the indication of the user input and the coded messages; and changing with load control circuitry of the load control module an operation of a device responsive to the control signals.

The first communication protocol can be powerline signaling and the second communication protocol can be radio frequency (RF) signaling. Transmitting and receiving the coded messages can occur synchronously over the mesh network using the powerline signaling and the RF signaling based on zero crossings of the powerline waveform. The powerline signaling can comprise message data modulated onto a carrier signal and the data modulated carrier signal can be added to the powerline waveform, and the RF signaling can comprises the message data modulated onto a RF signal.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

These drawings and the associated description herein are provided to illustrate specific embodiments and are not intended to be limiting.

FIG. 1 is an exploded view of an in-wall system according to certain embodiments.

FIG. 2 is a block diagram of a powerline and radio frequency communication network, according to certain embodiments.

FIG. 3 is a block diagram illustrating message retransmission within the communication network, according to certain embodiments.

FIG. 4 illustrates a process to receive messages within the communication network, according to certain embodiments.

FIG. 5 illustrates a process to transmit messages to groups of devices within the communication network, according to certain embodiments.

FIG. 6 illustrates a process to transmit direct messages with retries to devices within the communication network, according to certain embodiments.

FIG. 7 is a block diagram illustrating the overall flow of information related to sending and receiving messages over the communication network, according to certain embodiments.

FIG. 8 is a block diagram illustrating the overall flow of information related to transmitting messages on the powerline, according to certain embodiments.

FIG. 9 is a block diagram illustrating the overall flow of information related to receiving messages from the powerline, according to certain embodiments.

FIG. 10 illustrates a powerline signal, according to certain embodiments.

FIG. 11 illustrates a powerline signal with transition smoothing, according to certain embodiments.

FIG. 12 illustrates powerline signaling applied to the powerline, according to certain embodiments.

FIG. 13 illustrates standard message packets applied to the powerline, according to certain embodiments.

FIG. 14 illustrates extended message packets applied to the powerline, according to certain embodiments.

FIG. 15 is a block diagram illustrating the overall flow of information related to transmitting messages via RF, according to certain embodiments.

FIG. 16 is a block diagram illustrating the overall flow of information related to receiving messages via RF, according to certain embodiments.

FIG. 17 is a table of exemplary specifications for RF signaling within the communication network, according to certain embodiments.

FIGS. 18-29 illustrate exemplary user interfaces, load control modules, and mounting brackets for an in-wall system, according to certain embodiments.

### DETAILED DESCRIPTION OF THE PREFERRED EMBODIMENT

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

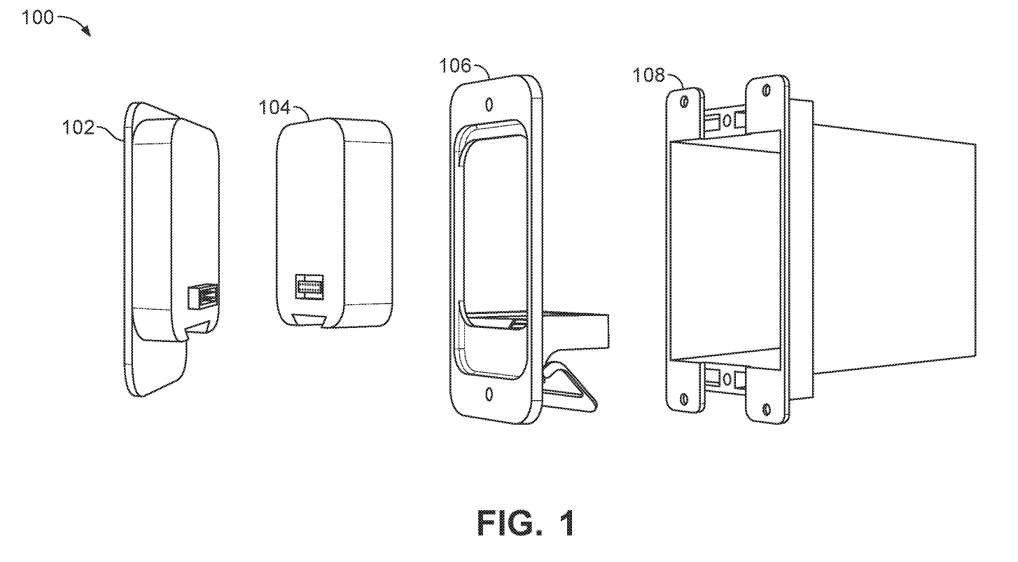

FIG. 1 illustrates an exploded view of the modular in-wall load control device 100 that, when assembled, mounts to an electrical wall box 108. In an embodiment, the modular in-wall load control device 100 comprises a user interface module 102, a load control module 104, and a backplate or mounting bracket/mounting plate 106.

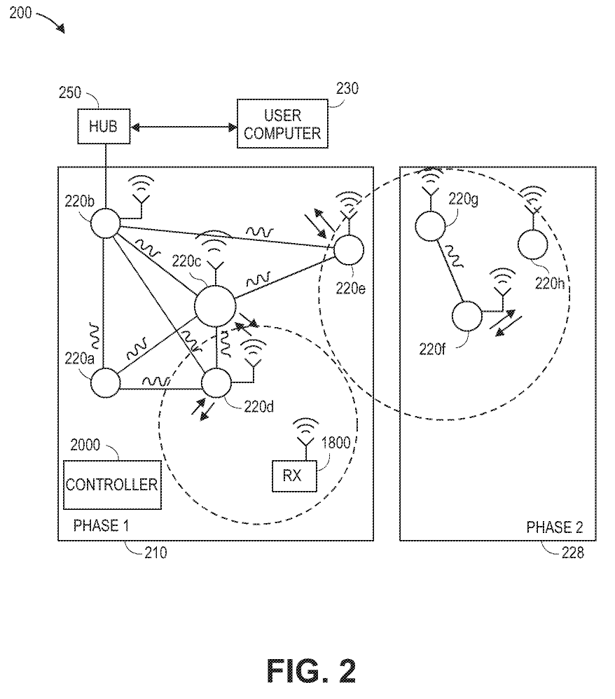

FIG. 2 illustrates the communication network 200 of control and communication devices 220 communicating over the network 200 using one or more of powerline signaling and RF signaling. The network 200 further comprises the local controller 1800 communicating over the network 200 using the RF signaling. In an embodiment, the communication network 200 comprises a mesh network. In another embodiment, the communication network 200 comprises a simulcast mesh network. In a further embodiment, the communication network 200 comprises an INSTEON® network.

Electrical power is most commonly distributed to buildings and homes in North America as single split-phase alternating current. At the main junction box to the building, the three-wire single-phase distribution system is split into two two-wire 110 VAC powerlines, known as Phase 1 and Phase 2. Phase 1 wiring is typically used for half the circuits in the building and Phase 2 is used for the other half. In the exemplary network 200, devices 220a-220e are connected to a Phase 1 powerline 210 and devices 220f-220h are connected to a Phase 2 powerline 228.

In the network 200, device 220a is configured to communicate over the powerline; device 220h is configured to communicate via RF; and devices 220b-220g are configured to communicate over the powerline and via RF. Additionally device 220b can be configured to communicate to a hub 250 and the hub 250 can be configured to communicate with a computer 230 and other digital equipment using, for example, RS232, USB, IEEE 802.3, or Ethernet protocols and communication hardware. Hub 250 on the network 200 communicating with the computer 230 and other digital devices can, for example, bridge to networks of otherwise incompatible devices in a building, connect to computers, act as nodes on a local-area network (LAN), or get onto the global Internet. In an embodiment, the computer 230 comprises a personal computer, a laptop, a tablet, a smartphone, or the like, and interfaces with a user.

Further, hub 250 can be configured to receive messages containing data from the local controller 2000 via the local receiver 1800 and the network 200. The hub 250 can further be configured to provide information to a user through the computer 230, and can be configured to provide data and/or commands to the local controller 2000 via the local receiver 1800 and the network 200.

In an embodiment, devices 220a-220g that send and receive messages over the powerline use the INSTEON® Powerline protocol, and devices 220b-220h that send and receive radio frequency (RF) messages use the INSTEON® RF protocol, as defined in U.S. Pat. Nos. 7,345,998 and 8,081,649 which are hereby incorporated by reference herein in their entireties. INSTEON® is a trademark of the applicant.

Devices 220b-220h that use multiple media or layers solve a significant problem experienced by devices that only communicate via the powerline, such as device 220a, or by devices that only communicate via RF, such as device 220h. Powerline signals on opposite powerline phases 210 and 228 are severely attenuated because there is no direct circuit connection for them to travel over. RF barriers can prevent direct RF communication between devices RF only devices. Using devices capable of communicating over two or more of the communication layers solves the powerline phase coupling problem whenever such devices are connected on opposite powerline phases and solves problems with RF barriers between RF devices. Thus, within the network 200, the powerline layer assists the RF layer, and the RF layer assists the powerline layer.

As shown in FIG. 2, device 220a is installed on powerline Phase 1 210 and device 220f is installed on powerline Phase 2 228. Device 220a can communicate via powerline with devices 220b-220e on powerline Phase 1 210, but it can also communicate via powerline with device 220f on powerline Phase 2 228 because it can communicate over the powerline to device 220e, which can communicate to device 220f using RF signaling, which in turn is directly connected to powerline Phase 2 228. The dashed circle around device 220f represents the RF range of device 220f. Direct RF paths between devices 220e to 220f (1 hop), for example, or indirect paths between devices 220c to 220e and between devices 220e to 220f, for example (2 hops) allow messages to propagate between the powerline phases.

Each device 220a-220h is configured to repeat messages to others of the devices 220a-220h on the network 200. In an embodiment, each device 220a-220h is capable of repeating messages, using the protocols as described herein. Further, the devices 220a-220h and 1800 are peers, meaning that any device can act as a master (sending messages), slave (receiving messages), or repeater (relaying messages). Adding more devices configured to communicate over more than one physical layer increases the number of available pathways for messages to travel. Path diversity results in a higher probability that a message will arrive at its intended destination.

For example, RF device 220d desires to send a message to device 220e, but device 220e is out of range. The message will still get through, however, because devices within range of device 220d, such as devices 220a-220c will receive the message and repeat it to other devices within their respective ranges. There are many ways for a message to travel: device 220d to 220c to 220e (2 hops), device 220d to 220a to 220c to 220e (3 hops), device 220d to 220b to 220a to 220c to 220e (4 hops) are some examples.

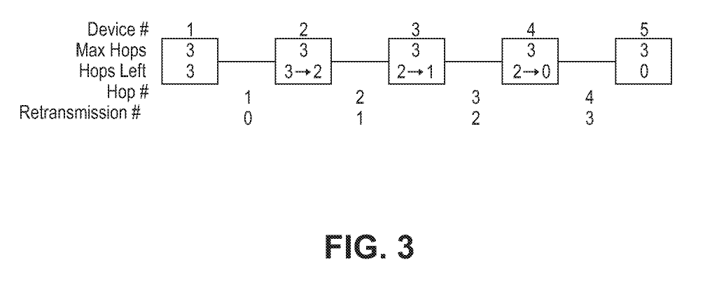

FIG. 3 is a block diagram illustrating message retransmission within the communication network 200. In order to improve network reliability, the devices 220 retransmit messages intended for other devices on the network 200. This increases the range that the message can travel to reach its intended device recipient.

Unless there is a limit on the number of hops that a message may take to reach its final destination, messages might propagate forever within the network 200 in a nested series of recurring loops. Network saturation by repeating messages is known as a “data storm.” The message protocol avoids this problem by limiting the maximum number of hops an individual message may take to some small number. In an embodiment, messages can be retransmitted a maximum of three times. In other embodiments, the number of times a message can be retransmitted is less than 3. In further embodiments, the number of times a message can be retransmitted is greater than 3. The larger the number of retransmissions, however, the longer the message will take to complete.

Embodiments comprise a pattern of transmissions, retransmissions, and acknowledgements that occurs when messages are sent. Message fields, such as Max Hops and Hops Left manage message retransmission. In an embodiment, messages originate with the 2-bit Max Hops field set to a value of 0, 1, 2, or 3, and the 2-bit Hops Left field set to the same value. A Max Hops value of zero tells other devices 220 within range not to retransmit the message. A higher Max Hops value tells devices 220 receiving the message to retransmit it depending on the Hops Left field. If the Hops Left value is one or more, the receiving device 220 decrements the Hops Left value by one and retransmits the message with the new Hops Left value. Devices 220 that receive a message with a Hops Left value of zero will not retransmit that message. Also, the device 220 that is the intended recipient of a message will not retransmit the message, regardless of the Hops Left value.

In other words, Max Hops is the maximum retransmissions allowed. All messages “hop” at least once, so the value in the Max Hops field is one less than the number of times a message actually hops from one device to another. In embodiments where the maximum value in this field is three, there can be four actual hops, comprising the original transmission and three retransmissions. Four hops can span a chain of five devices. This situation is shown schematically in FIG. 3.

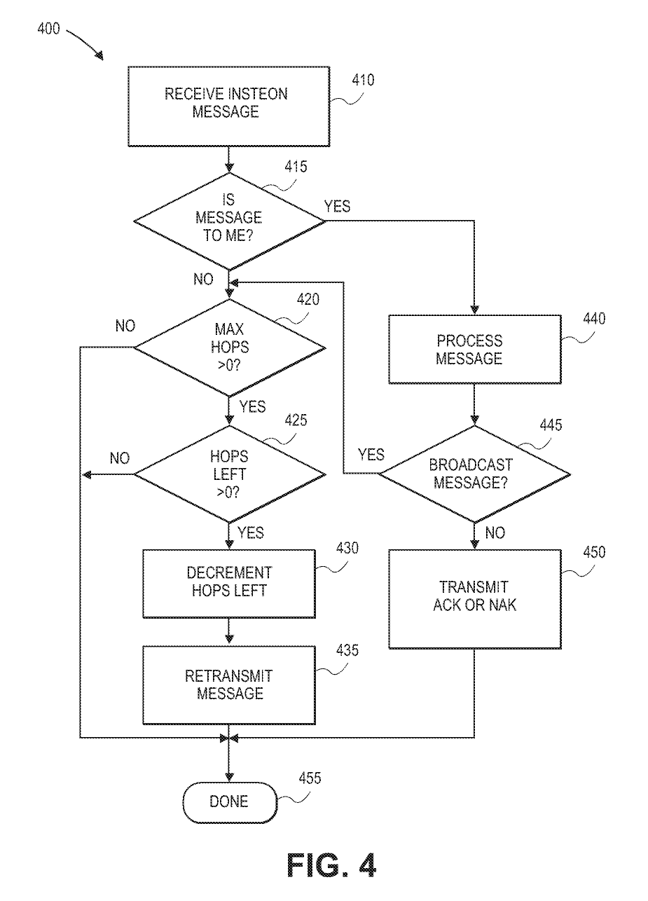

FIG. 4 illustrates a process 400 to receive messages within the communication network 200. The flowchart in FIG. 4 shows how the device 220 receives messages and determines whether to retransmit them or process them. At step 410, the device 220 receives a message via powerline or RF.

At step 415, the process 400 determines whether the device 220 needs to process the received message. The device 220 processes Direct messages when the device 220 is the addressee, processes Group Broadcast messages when the device 220 is a member of the group, and processes all Broadcast messages.

If the received message is a Direct message intended for the device 220, a Group Broadcast message where the device 220 is a group member, or a Broadcast message, the process 400 moves to step 440. At step 440, the device 220 processes the received message.

At step 445, the process 400 determines whether the received message is a Group Broadcast message or one of a Direct message and Direct group-cleanup message. If the message is a Direct or Direct Group-cleanup message, the process moves to step 450. At step 450, the device sends an acknowledge (ACK) or a negative acknowledge (NAK) message back to the message originator in step 450 and ends the task at step 455.

In an embodiment, the process 400 simultaneously sends the ACK/NAK message over the powerline and via RF. In another embodiment, the process 400 intelligently selects which physical layer (powerline, RF) to use for ACK/NAK message transmission. In a further embodiment, the process 400 sequentially sends the ACK/NAK message using a different physical layer for each subsequent retransmission.

If at step 445, the process 400 determines that the message is a Broadcast or Group Broadcast message, the process 400 moves to step 420. If, at step 415, the process 400 determines that the device 220 does not need to process the received message, the process 400 also moves to step 420. At step 420, the process 400 determines whether the message should be retransmitted.

At step 420, the Max Hops bit field of the Message Flags byte is tested. If the Max Hops value is zero, process 400 moves to step 455, where it is done. If the Max Hops filed is not zero, the process moves to step 425, where the Hops Left filed is tested.

If there are zero Hops Left, the process 400 moves to step 455, where it is finished. If the Hops Left field is not zero, the process 400 moves to step 430, where the process 400 decrements the Hops Left value by one.

At step 435, the process 400 retransmits the message. In an embodiment, the process 400 simultaneously retransmits the message over the powerline and via RF. In another embodiment, the process 400 intelligently selects which physical layer (PL, RF) to use for message retransmission. In a further embodiment, the process 400 sequentially retransmits the message using a different physical layer for each subsequent retransmission.

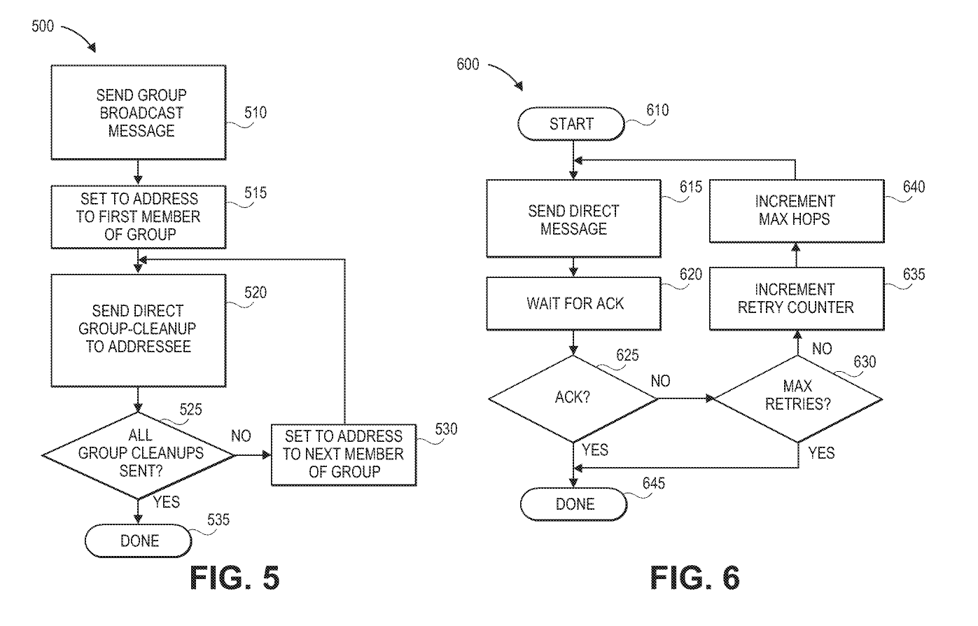

FIG. 5 illustrates a process 500 to transmit messages to multiple recipient devices 220 in a group within the communication network 200. Group membership is stored in a database in the device 220 following a previous enrollment process. At step 510, the device 220 first sends a Group Broadcast message intended for all members of a given group. The Message Type field in the Message Flags byte is set to signify a Group Broadcast message, and the To Address field is set to the group number, which can range from 0 to 255. The device 220 transmits the message using at least one of powerline and radio frequency signaling. In an embodiment, the device 220 transmits the message using both powerline and radio frequency signaling.

Following the Group Broadcast message, the transmitting device 220 sends a Direct Group-cleanup message individually to each member of the group in its database. At step 515 the device 220 first sets the message To Address to that of the first member of the group, then it sends a Direct Group-cleanup message to that addressee at step 520. If Group-cleanup messages have been sent to every member of the group, as determined at step 525, transmission is finished at step 535. Otherwise, the device 220 sets the message To Address to that of the next member of the group and sends the next Group-cleanup message to that addressee at step 520.

FIG. 6 illustrates a process 600 to transmit direct messages with retries to the device 220 within the communication network 200. Direct messages can be retried multiple times if an expected ACK is not received from the addressee. The process begins at step 610.

At step 615, the device 220 sends a Direct or a Direct Group-cleanup message to an addressee. At step 620 the device 220 waits for an Acknowledge message from the addressee. If, at step 625, an Acknowledge message is received and it contains an ACK with the expected status, the process 600 is finished at step 645.

If, at step 625, an Acknowledge message is not received, or if it is not satisfactory, a Retry Counter is tested at step 630. If the maximum number of retries has already been attempted, the process 600 fails at step 645. In an embodiment, devices 220 default to a maximum number of retries of five. If fewer than five retries have been tried at step 630, the device 220 increments its Retry Counter at step 635. At step 640, the device 220 will also increment the Max Hops field in the Message Flags byte, up to a maximum of three, in an attempt to achieve greater range for the message by retransmitting it more times by more devices 220. The message is sent again at step 615.

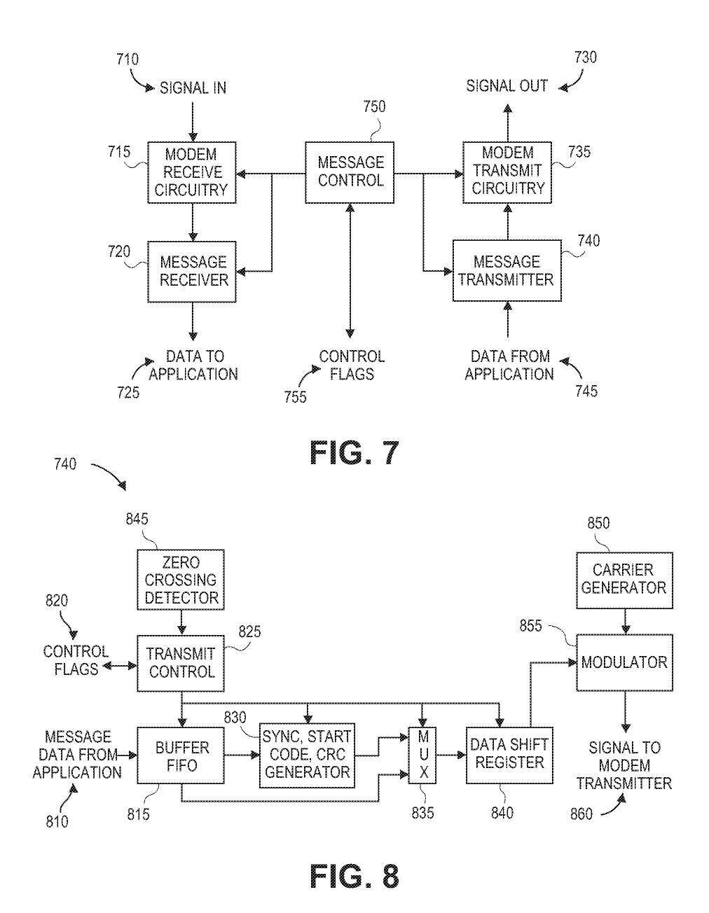

The devices 220 comprise hardware and firmware that enable the devices 220 to send and receive messages. FIG. 7 is a block diagram of the device 220 illustrating the overall flow of information related to sending and receiving messages. Received signals 710 come from the powerline, via radio frequency, or both. Signal conditioning circuitry 715 processes the raw signal and converts it into a digital bitstream. Message receiver firmware 720 processes the bitstream as required and places the message payload data into a buffer 725 which is available to the application running on the device 220. A message controller 750 tells the application that data is available using control flags 755.

To send a message, the application places message data in a buffer 745, then tells the message controller 750 to send the message using the control flags 755. Message transmitter 740 processes the message into a raw bitstream, which it feeds to a modem transmitter 735. The modem transmitter 735 sends the bitstream as a powerline signal, a radio frequency signal, or both.

FIG. 8 shows the message transmitter 740 of FIG. 7 in greater detail and illustrates the device 220 sending a message on the powerline. The application first composes a message 810 to be sent, excluding the cyclic redundancy check (CRC) byte, and puts the message data in a transmit buffer 815. The application then tells a transmit controller 825 to send the message by setting appropriate control flags 820. The transmit controller 825 packetizes the message data using multiplexer 835 to put sync bits and a start code from a generator 830 at the beginning of a packet followed by data shifted out of the first-in first-out (FIFO) transmit buffer 815.

As the message data is shifted out of FIFO transmit buffer 815, the CRC generator 830 calculates the CRC byte, which is appended to the bitstream by the multiplexer 835 as the last byte in the last packet of the message. The bitstream is buffered in a shift register 840 and clocked out in phase with the powerline zero crossings detected by zero crossing detector 845. The phase shift keying (PSK) modulator 855 shifts the phase of an approximately 131.65 kHz carrier signal from carrier generator 850 by 180 degrees for zero-bits, and leaves the carrier signal unmodulated for one-bits. In other embodiments, the carrier signal can be greater than or less than approximately 131.65 kHz. Note that the phase is shifted gradually over one carrier period as disclosed in conjunction with FIG. 11. Finally, the modulated carrier signal is applied to the powerline by the modem transmit circuitry 735 of FIG. 7.

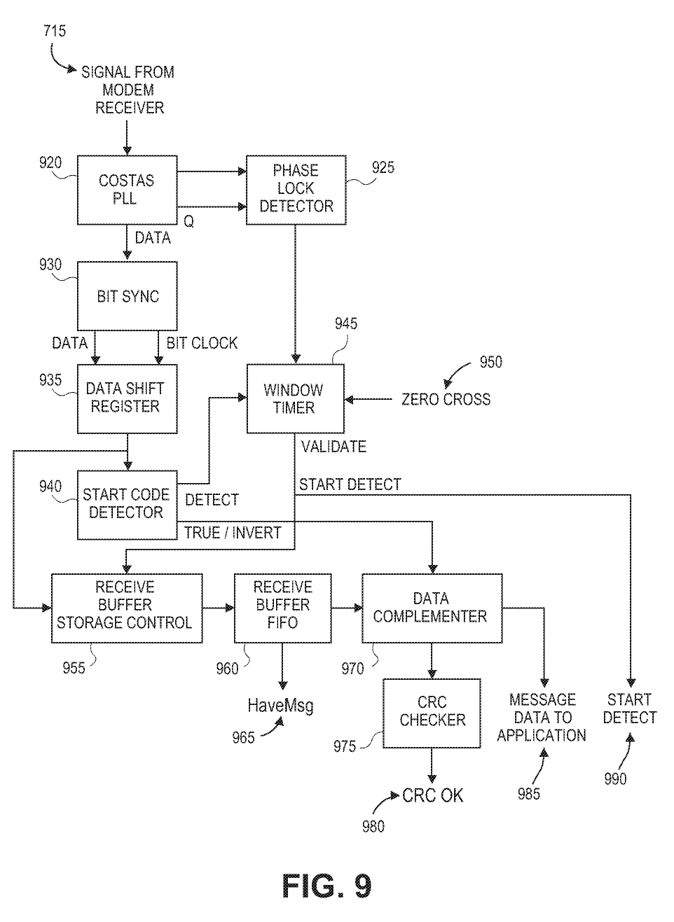

FIG. 9 shows message receiver 720 of FIG. 7 in greater detail and illustrates the device 220 receiving a message from the powerline. The modem receive circuitry 715 of FIG. 7 conditions the signal on the powerline and transforms it into a digital data stream that the firmware in FIG. 9 processes to retrieve messages. Raw data from the powerline is typically very noisy, because the received signal amplitude can be as low as only few millivolts, and the powerline often carries high-energy noise spikes or other noise of its own. Therefore, in an embodiment, a Costas phase-locked-loop (PLL) 920, implemented in firmware, is used to find the PSK signal within the noise. Costas PLLs, well known in the art, phase-lock to a signal both in phase and in quadrature. A phase-lock detector 925 provides one input to a window timer 945, which also receives a zero crossing signal 950 and an indication that a start code in a packet has been found by start code detector 940.

Whether it is phase-locked or not, the Costas PLL 920 sends data to the bit sync detector 930. When the sync bits of alternating ones and zeros at the beginning of a packet arrive, the bit sync detector 930 will be able to recover a bit clock, which it uses to shift data into data shift register 935. The start code detector 940 looks for the start code following the sync bits and outputs a detect signal to the window timer 945 after it has found one. The window timer 945 determines that a valid packet is being received when the data stream begins approximately 800 microseconds before the powerline zero crossing, the phase lock detector 925 indicates lock, and detector 940 has found a valid start code. At that point the window timer 945 sets a start detect flag 990 and enables the receive buffer controller 955 to begin accumulating packet data from shift register 935 into the FIFO receive buffer 960. The storage controller 955 insures that the FIFO 960 builds up the data bytes in a message, and not sync bits or start codes. It stores the correct number of bytes, 10 for a standard message and 24 for an extended message, for example, by inspecting the Extended Message bit in the Message Flags byte. When the correct number of bytes has been accumulated, a HaveMsg flag 965 is set to indicate a message has been received.

Costas PLLs have a phase ambiguity of 180 degrees, since they can lock to a signal equally well in phase or anti-phase. Therefore, the detected data from PLL 920 may be inverted from its true sense. The start code detector 940 resolves the ambiguity by looking for the true start code, C3 hexadecimal, and also its complement, 3C hexadecimal. If it finds the complement, the PLL is locked in antiphase and the data bits are inverted. A signal from the start code detector 940 tells the data complementer 970 whether to un-invert the data or not. The CRC checker 975 computes a CRC on the received data and compares it to the CRC in the received message. If they match, the CRC OK flag 980 is set.

Data from the complementer 970 flows into an application buffer, not shown, via path 985. The application will have received a valid message when the HaveMsg flag 965 and the CRC OK flag 980 are both set.

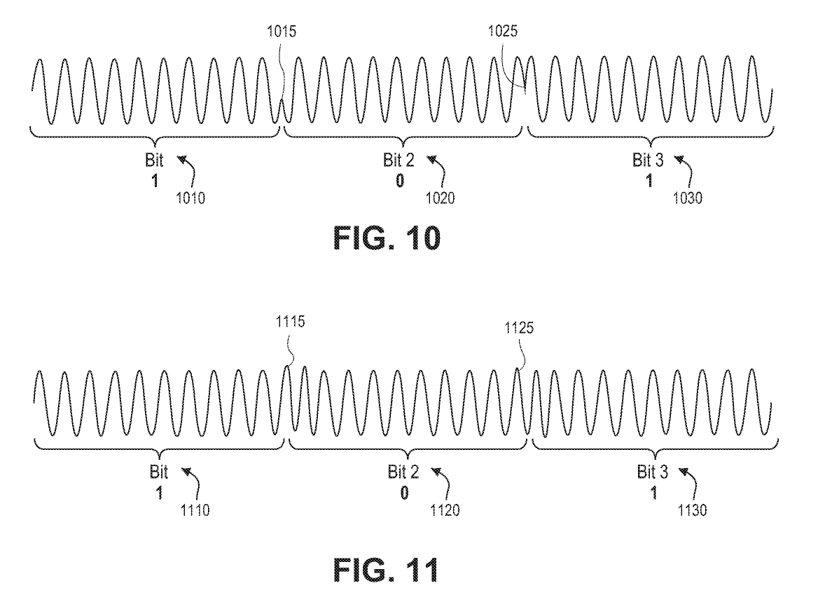

FIG. 10 illustrates an exemplary 131.65 kHz powerline carrier signal with alternating BPSK bit modulation. Each bit uses ten cycles of carrier. Bit 1010, interpreted as a one, begins with a positive-going carrier cycle. Bit 2 1020, interpreted as a zero, begins with a negative-going carrier cycle. Bit 3 1030, begins with a positive-going carrier cycle, so it is interpreted as a one. Note that the sense of the bit interpretations is arbitrary. That is, ones and zeros could be reversed as long as the interpretation is consistent. Phase transitions only occur when a bitstream changes from a zero to a one or from a one to a zero. A one followed by another one, or a zero followed by another zero, will not cause a phase transition. This type of coding is known as NRZ or nonreturn to zero.

FIG. 10 shows abrupt phase transitions of 180 degrees at the bit boundaries 1015 and 1025. Abrupt phase transitions introduce troublesome high-frequency components into the signal's spectrum. Phase-locked detectors can have trouble tracking such a signal. To solve this problem, the powerline encoding process uses a gradual phase change to reduce the unwanted frequency components.

FIG. 11 illustrates the powerline BPSK signal of FIG. 10 with gradual phase shifting of the transitions. The transmitter introduces the phase change by inserting approximately 1.5 cycles of carrier at 1.5 times the approximately 131.65 kHz frequency. Thus, in the time taken by one cycle of 131.65 kHz, three half-cycles of carrier will have occurred, so the phase of the carrier is reversed at the end of the period due to the odd number of half-cycles. Note the smooth transitions 1115 and 1125.

In an embodiment, the powerline packets comprise 24 bits. Since a bit takes ten cycles of 131.65 kHz carrier, there are 240 cycles of carrier in a packet, meaning that a packet lasts approximately 1.823 milliseconds. The powerline environment is notorious for uncontrolled noise, especially high-amplitude spikes caused by motors, dimmers and compact fluorescent lighting. This noise is minimal during the time that the current on the powerline reverses direction, a time known as the powerline zero crossing. Therefore, the packets are transmitted near the zero crossing.

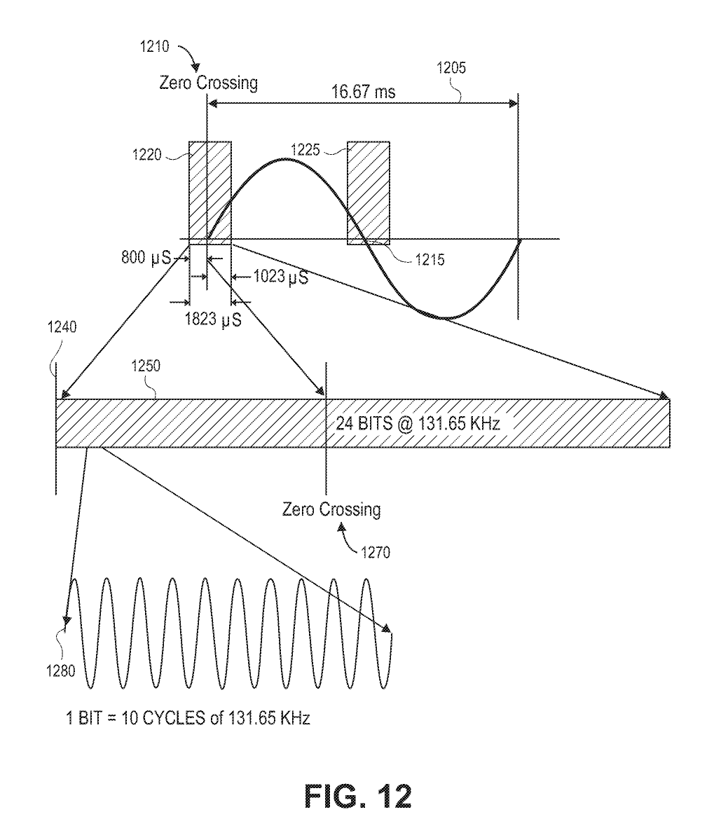

FIG. 12 illustrates powerline signaling applied to the powerline. Powerline cycle 1205 possesses two zero crossings 1210 and 1215. A packet 1220 is at zero crossing 1210 and a second packet 1225 is at zero crossing 1215. In an embodiment, the packets 1220, 1225 begin approximately 800 microseconds before a zero crossing and last until approximately 1023 microseconds after the zero crossing.

In some embodiments, the powerline transmission process waits for one or two additional zero crossings after sending a message to allow time for potential RF retransmission of the message by devices 220.

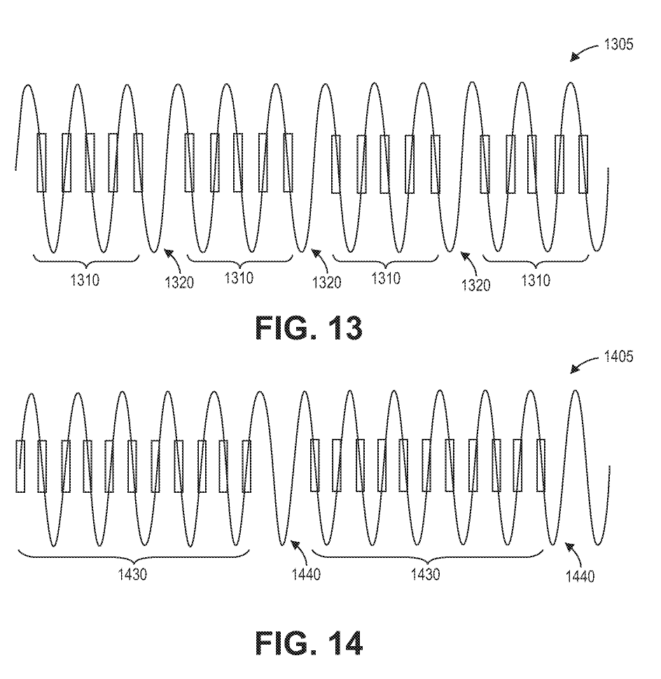

FIG. 13 illustrates an exemplary series of five-packet standard messages 1310 being sent on powerline signal 1305. In an embodiment, the powerline transmission process waits for at least one zero crossing 1320 after each standard message 1310 before sending another packet. FIG. 14 illustrates an exemplary series of eleven-packet extended messages 1430 being sent on the powerline signal 1405. In another embodiment, the powerline transmission process waits for at least two zero crossings 1440 after each extended message before sending another packet. In other embodiments, the powerline transmission process does not wait for extra zero crossings before sending another packet.

In some embodiments, standard messages contain 120 raw data bits and use six zero crossings, or approximately 50 milliseconds to send. In some embodiments, extended messages contain 264 raw data bits and use thirteen zero crossings, or approximately 108.33 milliseconds to send. Therefore, the actual raw bitrate is approximately 2,400 bits per second for standard messages 1310, and approximately 2,437 bits per second for extended messages 1430, instead of the 2880 bits per second the bitrate would be without waiting for the extra zero crossings 1320, 1440.

In some embodiments, standard messages contain 9 bytes (72 bits) of usable data, not counting packet sync and start code bytes, nor the message CRC byte. In some embodiments, extended messages contain 23 bytes (184 bits) of usable data using the same criteria. Therefore, the bitrates for usable data are further reduced to 1440 bits per second for standard messages 1310 and 1698 bits per second for extended messages 1430. Counting only the 14 bytes (112 bits) of User Data in extended messages, the User Data bitrate is 1034 bits per second.

The devices 220 can send and receive the same messages that appear on the powerline using radio frequency signaling. Unlike powerline messages, however, messages sent by radio frequency are not broken up into smaller packets sent at powerline zero crossings, but instead are sent whole. As with powerline, in an embodiment, there are two radio frequency message lengths: standard 10-byte messages and extended 24-byte messages.

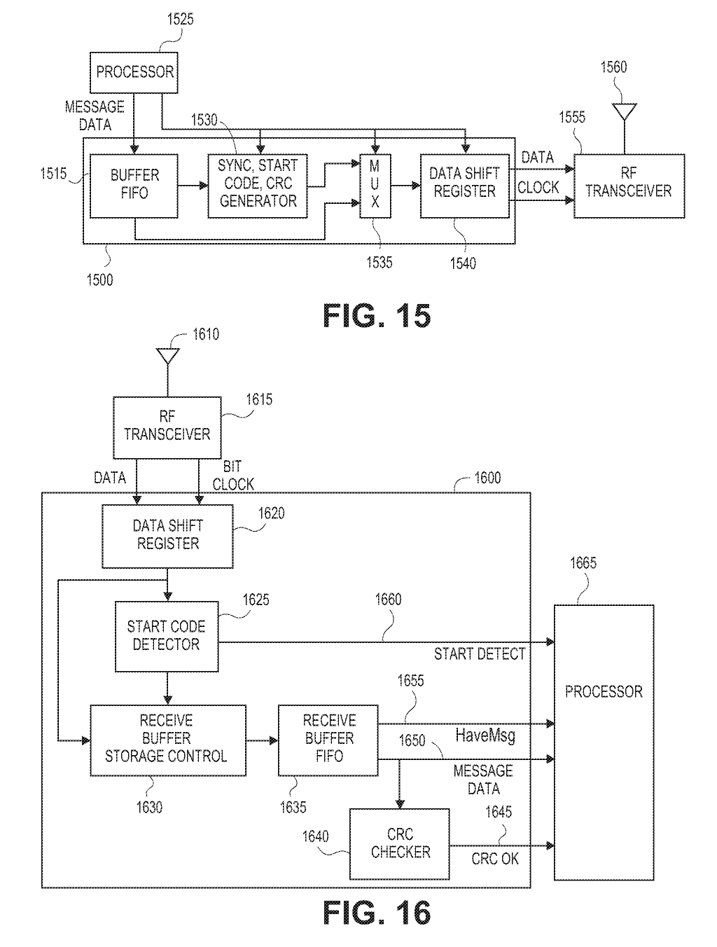

FIG. 15 is a block diagram illustrating message transmission using radio frequency (RF) signaling comprising processor 1525, RF transceiver 1555, antenna 1560, and RF transmit circuitry 1500. The RF transmit circuitry 1500 comprises a buffer FIFO 1525, a generator 1530, a multiplexer 1535, and a data shift register 1540.

The steps are similar to those for sending powerline messages in FIG. 8, except that radio frequency messages are sent all at once in a single packet. In FIG. 15, the processor 1525 composes a message to send, excluding the CRC byte, and stores the message data into the transmit buffer 1515. The processor 1525 uses the multiplexer 1535 to add sync bits and a start code from the generator 1530 at the beginning of the radio frequency message followed by data shifted out of the first-in first-out (FIFO) transmit buffer 1515.

As the message data is shifted out of FIFO 1515, the CRC generator 1530 calculates the CRC byte, which is appended to the bitstream by the multiplexer 1535 as the last byte of the message. The bitstream is buffered in the shift register 1540 and clocked out to the RF transceiver 1555. The RF transceiver 1555 generates an RF carrier, translates the bits in the message into Manchester-encoded symbols, frequency modulates the carrier with the symbol stream, and transmits the resulting RF signal using antenna 1560. In an embodiment, the RF transceiver 1555 is a single-chip hardware device and the other steps in FIG. 15 are implemented in firmware running on the processor 1525.

FIG. 16 is a block diagram illustrating message reception using the radio frequency signaling comprising processor 1665, RF transceiver 1615, antenna 1610, and RF receive circuitry 1600. The RF receive circuitry 1600 comprises a shift register 1620, a code detector 1625, a receive buffer storage controller 1630, a buffer FIFO 1635, and a CRC checker 1640.

The steps are similar to those for receiving powerline messages given in FIG. 9, except that radio frequency messages are sent all at once in a single packet. In FIG. 16, the RF transceiver 1615 receives an RF transmission from antenna 1610 and frequency demodulates it to recover the baseband Manchester symbols. The sync bits at the beginning of the message allow the transceiver 1615 to recover a bit clock, which it uses to recover the data bits from the Manchester symbols. The transceiver 1615 outputs the bit clock and the recovered data bits to shift register 1620, which accumulates the bitstream in the message.

The start code detector 1625 looks for the start code following the sync bits at the beginning of the message and outputs a detect signal 1660 to the processor 1665 after it has found one. The start detect flag 1660 enables the receive buffer controller 1630 to begin accumulating message data from shift register 1620 into the FIFO receive buffer 1635. The storage controller 1630 insures that the FIFO receive buffer 1635 stores the data bytes in a message, and not the sync bits or start code. In an embodiment, the storage controller 1630 stores 10 bytes for a standard message and 24 for an extended message, by inspecting the Extended Message bit in the Message Flags byte.

When the correct number of bytes has been accumulated, a HaveMsg flag 1655 is set to indicate a message has been received. The CRC checker 1640 computes a CRC on the received data and compares it to the CRC in the received message. If they match, the CRC OK flag 1645 is set. When the HaveMsg flag 1655 and the CRC OK flag 1645 are both set, the message data is ready to be sent to processor 1665. In an embodiment, the RF transceiver 1615 is a single-chip hardware device and the other steps in FIG. 16 are implemented in firmware running on the processor 1665.

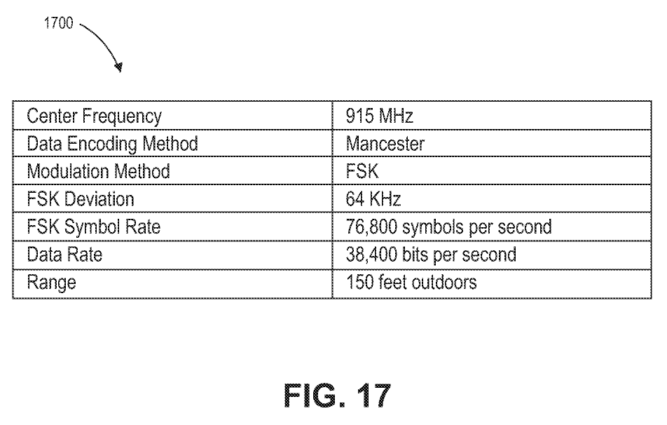

FIG. 17 is a table 1700 of exemplary specifications for RF signaling within the communication network 200. In an embodiment, the center frequency lies in the band of approximately 902 to 924 MHz, which is permitted for non-licensed operation in the United States. In certain embodiments, the center frequency is approximately 915 MHz. Each bit is Manchester encoded, meaning that two symbols are sent for each bit. A one-symbol followed by a zero-symbol designates a one-bit, and a zero-symbol followed by a one-symbol designates a zero-bit.

Symbols are modulated onto the carrier using frequency-shift keying (FSK), where a zero-symbol modulates the carrier by half of the FSK deviation frequency downward and a one-symbol modulates the carrier by half of the FSK deviation frequency upward. The FSK deviation frequency is approximately 64 kHz. In other embodiments, the FSK deviation frequency is between approximately 100 kHz and 200 kHz. In other embodiments the FSK deviation frequency is less than 64 kHz. In further embodiment, the FSK deviation frequency is greater than 200 kHz. Symbols are modulated onto the carrier at approximately 38,400 symbols per second, resulting in a raw data rata of half that, or 19,200 bits per second. The typical range for free-space reception is 150 feet, which is reduced in the presence of walls and other RF energy absorbers.

In other embodiments, other encoding schemes, such as return to zero (RZ), Nonreturn to Zero-Level (NRZ-L), Nonreturn to Zero Inverted (NRZI), Bipolar Alternate Mark Inversion (AMI), Pseudoternary, differential Manchester, Amplitude Shift Keying (ASK), Phase Shift Keying (PSK, BPSK, QPSK), and the like, could be used.

Devices transmit data with the most-significant bit sent first. In an embodiment, RF messages begin with two sync bytes comprising AAAA in hexadecimal, followed by a start code byte of C3 in hexadecimal. Ten data bytes follow in standard messages, or twenty-four data bytes in extended messages. The last data byte in a message is a CRC over the data bytes as disclosed above.

### In-Wall System

Referring to FIG. 1, in an embodiment, the in-wall system 100 comprises three main pieces: the user interface module 102, the load control module 104, and the mounting bracket/mounting plate 106. The in-wall system 100 is configured to allow the homeowner/end customer to safely and easily change the load control module 104. Each location of the in-wall system 100 can be easily changed by a non-electrician.

The user interface module 102 comprises a user interface having a configurable face for receiving user input from a user to control one or more devices 202 connected to the network 200. The user interface can be one or more of a toggle switch, a paddle switch, a keypad, other switch types, a control knob, an actuation device, a feedback device to provide the user with visual and/or audible indications, such as one or more LED's, and/or a speaker, The user interface can be simplistic logic level controls allowing simple switch level control and simple logic level indicators, or can easily be replaced with high complexity and cost user interfaces such as various high density dot matrix displays (e.g., LCD, OLED, E-Ink), motion detection, voice recognition, gesture sensing, camera, and/or various environmental sensor applications.

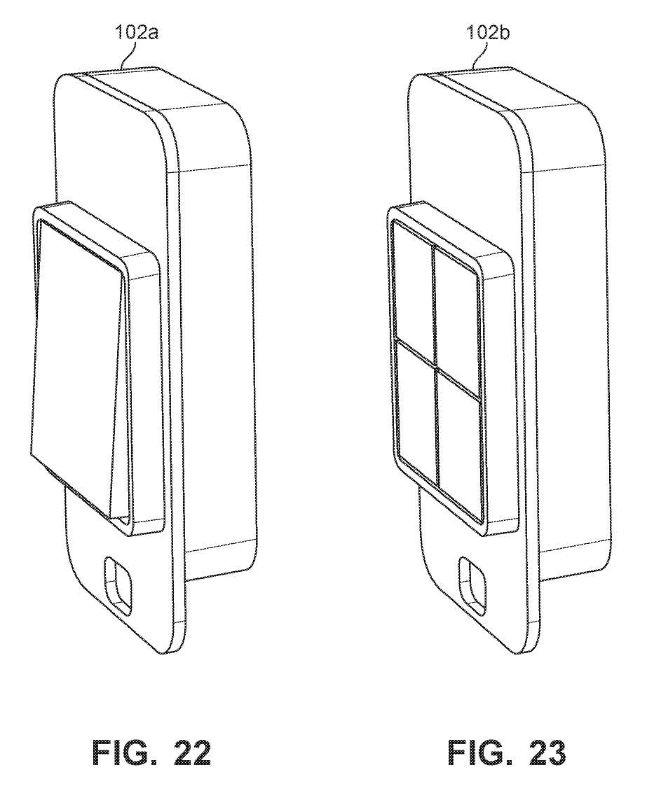

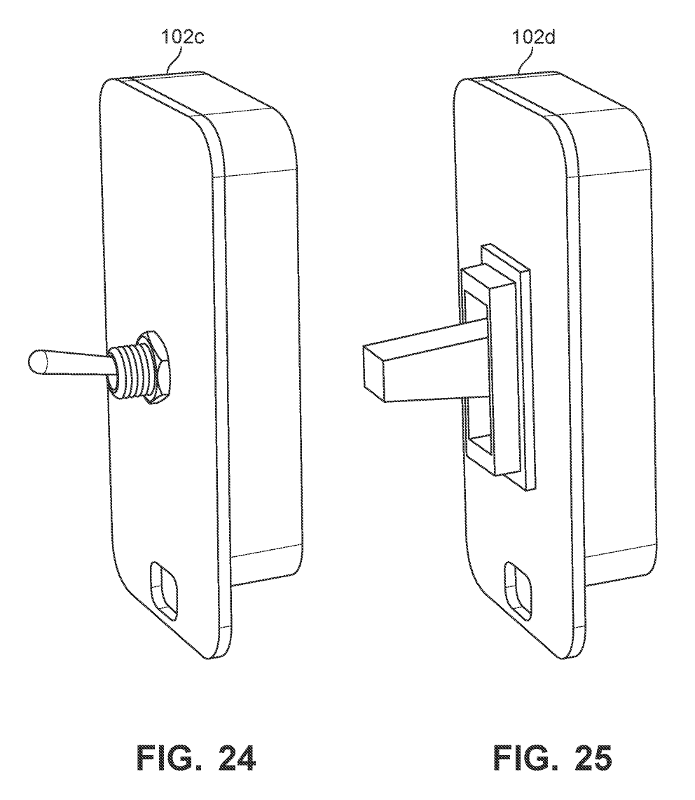

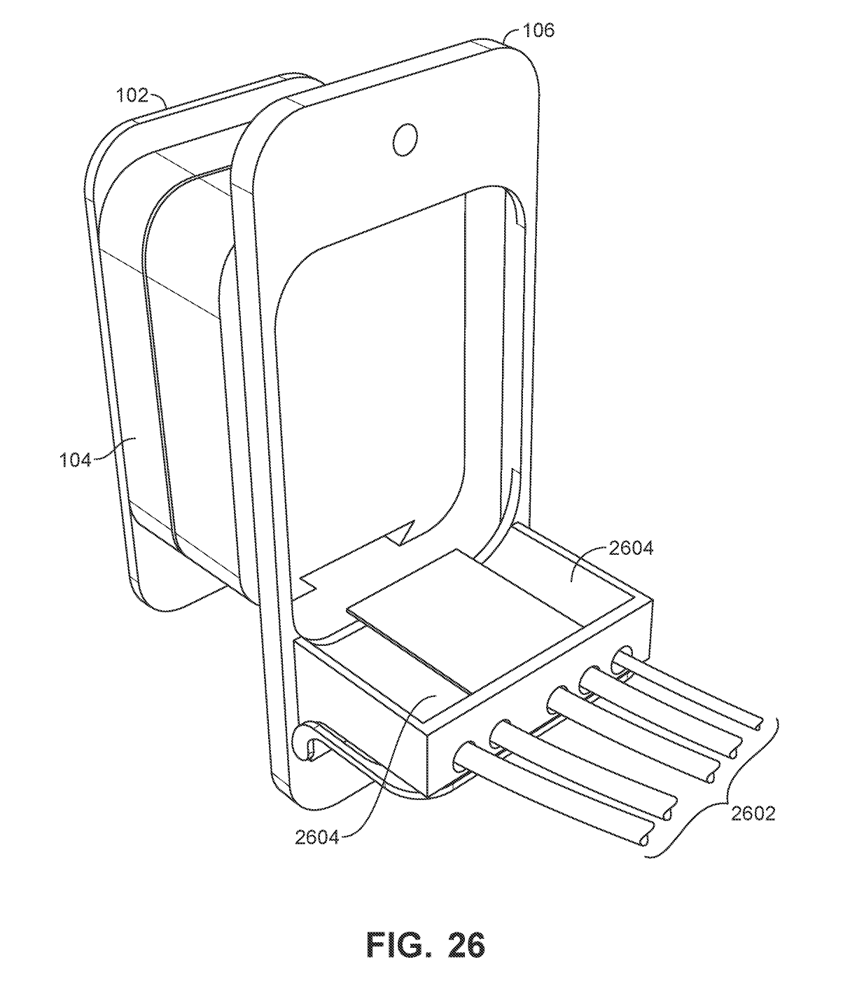

FIGS. 22-25 illustrate non-limiting examples of the configurable faces of the user interface modules 102a-102d. FIG. 22 illustrates an example of a user interface module 102a including a rocker switch; FIG. 23 illustrates an example of a user interface module 102b including a key pad; FIG. 24 illustrates an example of a user interface module 102c including a toggle switch; and FIG. 25 illustrates an example of a user interface module 102d including a switch. In some aspects, the user interface module 102 does not include RF regulatory components and does not include high voltage components. Thus, the user interface can undergo testing, such as electrostatic testing, for example, without the need for RF testing and without the need for high voltage safety testing. This allows creation of numerous user interface modules inexpensively.

In other aspects, the user interface module 102 can include a local receiver, such as the Insteon receiver local receiver and a low voltage radio, such the control and communication devices 220 described above with respect to FIGS. 2-17.

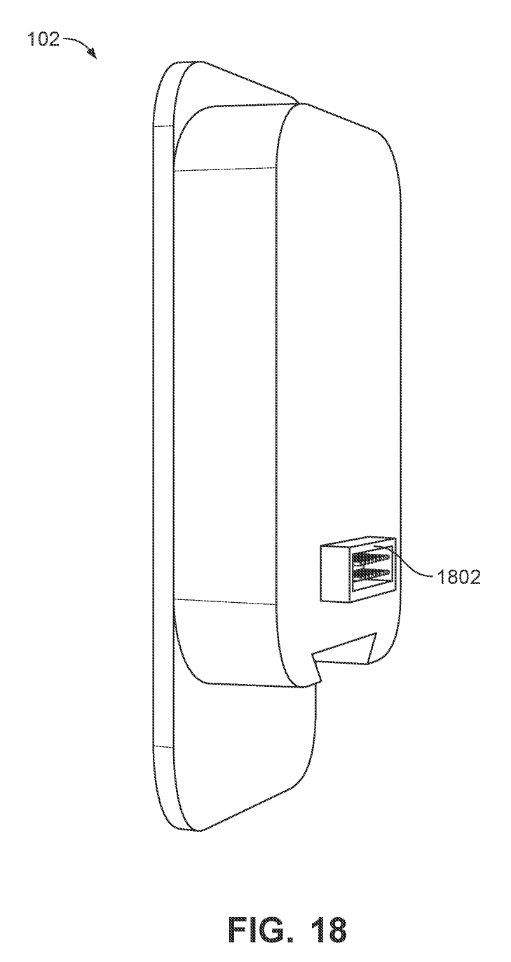

The user interface module 102 is in electrical communication with the load control module 104. FIG. 18 illustrates a rear perspective view of an embodiment of the user interface module 102 including a connector 1802 configured to mate with the load control unit 104. Examples of the connector 1802 can be, but not limited to spring metal conductors designed to compress and maintain electrical conductivity, or conducting male pins designed to provide a compression fit into female receptacles within the Load control module, or magnetic metal conductors designed to include opposite magnetic poles to provide magnetic adhesion.

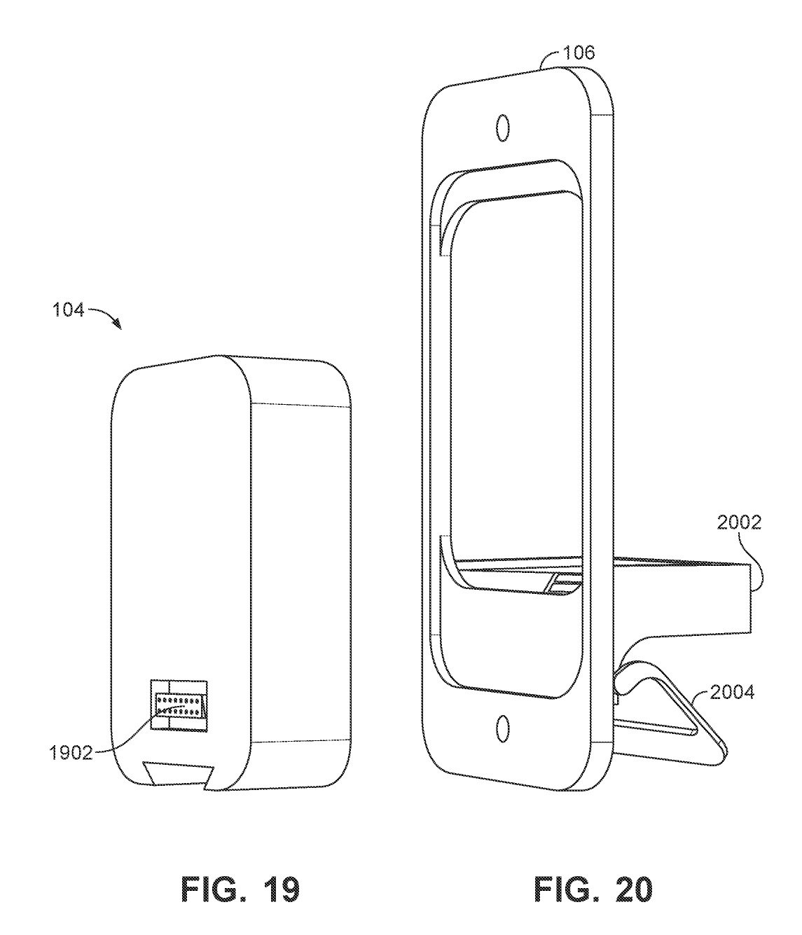

FIG. 19 illustrates a front perspective view of an embodiment of the load control module 104 including a receptacle 1902 configured to mate with connector 1802 of the user interface module 102.

In an embodiment, the load control module 104 comprises a local receiver and a low voltage radio. In certain aspects, the control and communication devices 220 described above with respect to FIGS. 2-17 comprise the local receiver and the low voltage radio. In an embodiment, the local receiver is the Insteon receiver.

The load control module 104 further comprises a power supply and a load control device (e.g., single, double, dimming or relay). In some aspects, the power supply receives the electrical signals from the power mains which supply electrical power to the house. The power supply can also down convert the electrical signal for use in the electronic circuitry of the local receiver and low voltage radio. The load control circuitry is configured to control the amount of power delivered to an electrical load from the AC power source, such as the power mains. In some instances the user interface signals will create a change in load control state, and in some instances it will not.

Load control can be various phase-cut dimming methods including but not limited to forward and reverse phase-cut dimming. Load control can also be via electromechanical contact closure for full conductivity or full disconnect. The load control module 104 may also allow measurement of voltage and current flow through the connected load.

The load control module 104 is in electrical communication with the mounting bracket/mounting plate 106. FIG. 20 illustrates an embodiment of the mounting bracket/mounting plate 106 including a harness 2002 and a clamp 2004. The mounting bracket/mounting plate 106 can have a metal bracket to include the proper screws held in place by a temporary plastic holder to aid in mounting to a standard wall box 108.

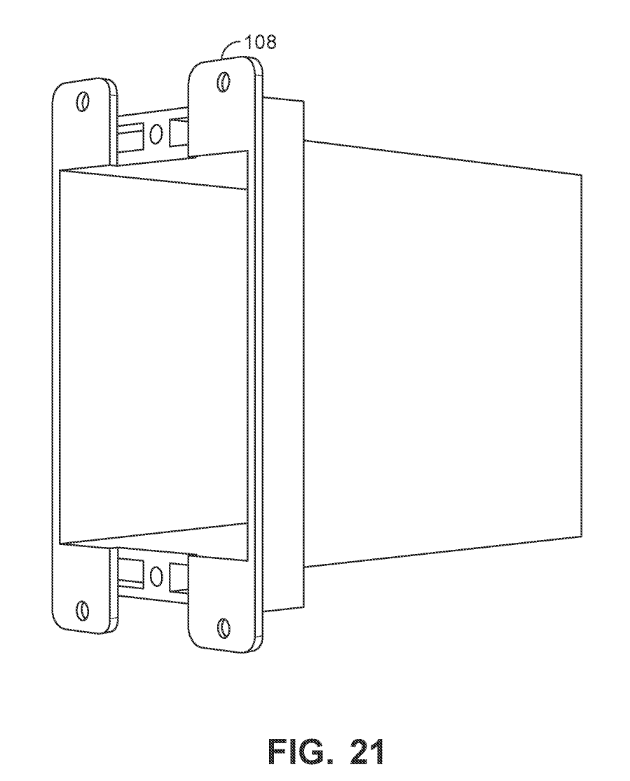

FIG. 21 illustrates an embodiment of the electrical wall box 108 that receives high voltage wiring, such as the high voltage wiring present in the high voltage cables found in residential house wiring that provide electrical service to the residence from electrical service providers. The high voltage wiring, such as the AC house wiring from the electrical wall box 108, is in electrical communication with the mounting bracket/mounting plate 106.

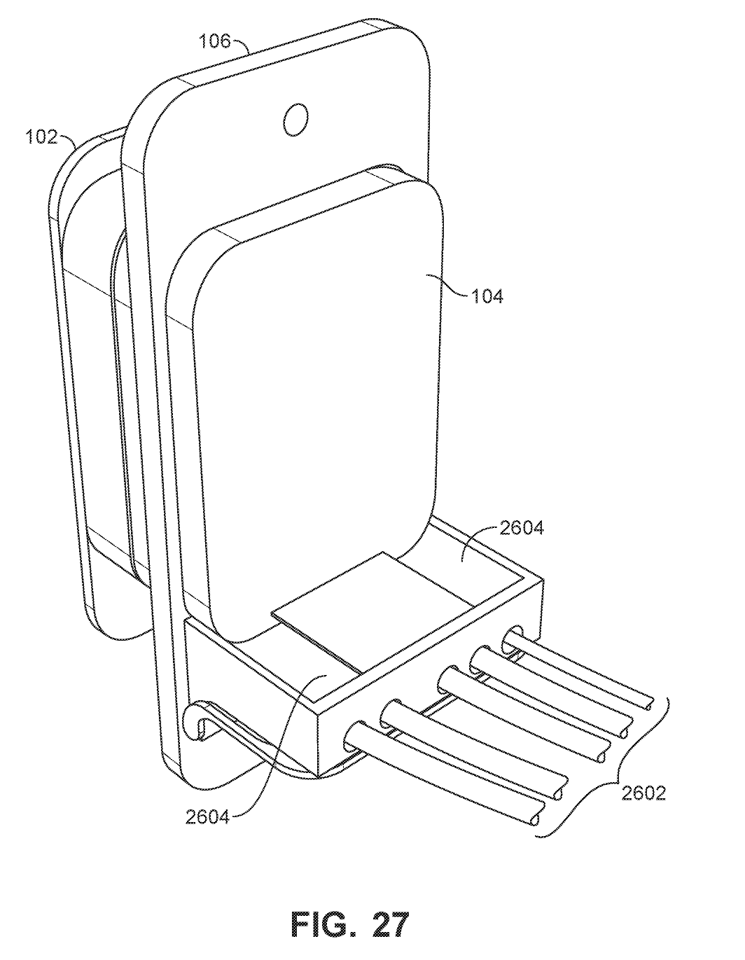

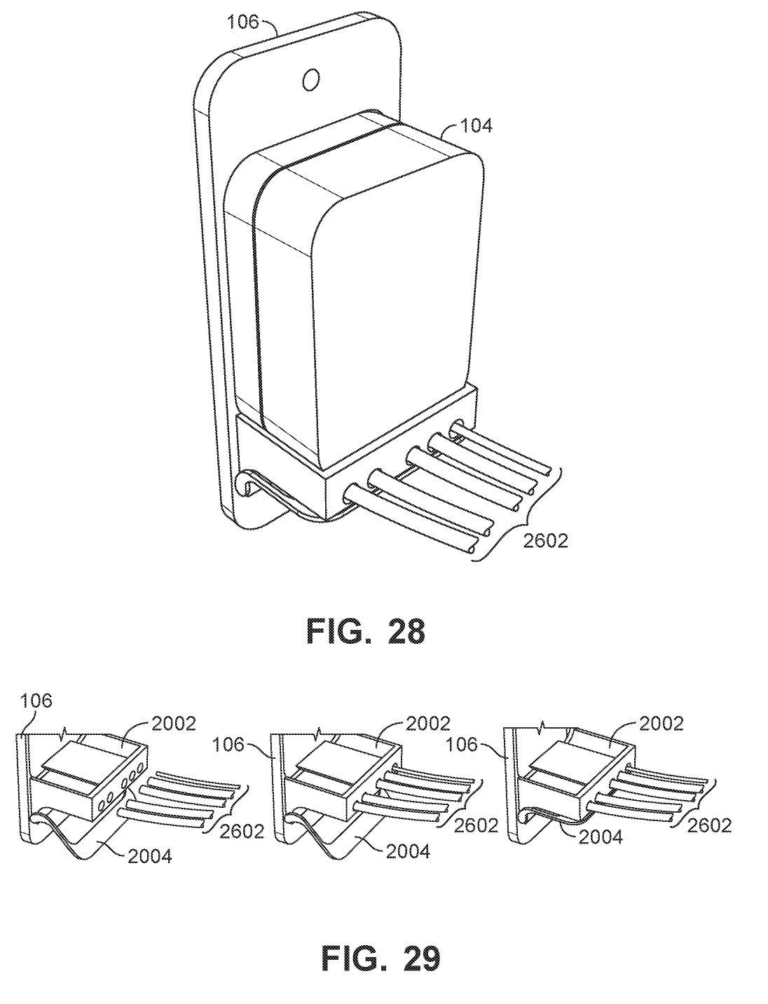

According aspects of the disclosure, FIGS. 26-28 illustrate the user interface module 102 coupled to the load control module 104 via the mating connectors 1802 and 1902 and further illustrate the assembly of the user interface module 102 and the load control module 104 sliding onto a track 2604 on the mounting bracket/mounting plate 106 to provide a secure mount and power from AC wiring 2602 to the load control module 104. The track 2604 can be formed on both sides of the mounting bracket/mounting plate 106, as illustrated in FIGS. 26-28 or the track 2604 can be provided on one of the sides of the mounting bracket/mounting plate 106 (not illustrated).

The mounting bracket/mounting plate 106 has no RF regulator components. Thus, the mounting bracket/mounting plate 106 can undergo high voltage testing without the need for RF testing.

In some aspects of the disclosure, the mounting bracket/mounting plate 106 can clamp directly onto an electrical cable including the AC wiring 2602, such as Romex®, without stripping the plastic sheath, outer wires, or individual wires. FIG. 29 illustrates an embodiment of the mounting bracket/mounting plate 106 that includes the harness 2002 and the clamp 2004. The individual wires of the AC wiring 2602 of the high voltage cable are inserted into the harness 2002 and clamped such that the clamp 2004 pierces through the insulation and locks the wires of the AC wiring 2602 in place to provide electrical connections between the mounting bracket/mounting plate 106 and the individual wires of the AC wiring 2602. In an aspect, the load control module 104 comprises a connector that mates with a corresponding connector on the mounting bracket/mounting plate 106 to provide electrical signals from the AC wiring 2602 to the load control module 104 for use in the Insteon receiver local receiver, low voltage radio, power supply, and load control device of the load control module 104.

Once the mounting bracket/mounting plate 106 is mounted to the electrical wall box 108, high voltage carried on the AC wiring 2602 would not be able to be in contact with the human finger.

The load control module 104 can identify itself to the communication network 200 via embedded memory, such as but not limited to SPI (Serial Peripheral Interface) memory, I²C (Inter-Integrated Circuit) memory, or the like, embedded in the load control module 104. In an embodiment, the memory stores an Insteon identification and specifics about the load for use by the load control module 104.

An air gap safety switch can activate when the user interface module 102 is installed. In an embodiment, a mechanical pin pushes two metal contacts together when the user interface module 102 connects to the load control module 104 to activate the air gap switch.

Conversely, when the user interface module 102 is removed from the load control module 104, the metal contacts have a spring tension that causes them to separate mechanically, to deactivate the air gap switch. Advantageously, it is safer to de-energize the load control module 104 when user interface module 102 is removed.

In some embodiments, the one load control module 104 supports dimming, on/off, and 2 wire (neutral-less) load control capabilities.

In some embodiments, the load control module 104 comprises a pull-tab for removal, or other means of releasing the load control module 104.

In some embodiments, the load control module 104 comprises a magnetic catch that locks the load control module 104 in place.

In some embodiments, the user interface module 102 acts as a lock-in place for the load control module 104.

In some embodiments, the in-wall module 100 further comprises an indication that the load control module 104 is properly installed and functional. In some embodiments, the indication indicates that the load is not controllable, but the power supply is active.

In some embodiments, the in-wall module 100 is configured to dampen the effect of installing the load control module 104 and releasing it.

Advantageously, the homeowner/end customer can safely and easily change the user interface module 102. In some embodiments, the changeable user interface module 102 allows the user to change user interfaces as desired, without un-powering the electrical wall box wiring.

### Terminology

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of certain embodiments is not intended to be exhaustive or to limit the invention to the precise form disclosed above. While specific embodiments of, and examples for, the invention are described above for illustrative purposes, various equivalent modifications are possible within the scope of the invention, as those ordinary skilled in the relevant art will recognize. For example, while processes, steps, or blocks are presented in a given order, alternative embodiments may perform routines having steps, or employ systems having blocks, in a different order, and some processes, steps, or blocks may be deleted, moved, added, subdivided, combined, and/or modified. Each of these processes, steps, or blocks may be implemented in a variety of different ways. Also, while processes, steps, or blocks are at times shown as being performed in series, these processes, steps, or blocks may instead be performed in parallel, or may be performed at different times.

The teachings of the invention provided herein can be applied to other systems, not necessarily the systems described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. An in-wall modular assembly to receive and transmit data and commands over a home network, the in-wall modular assembly comprising:
a mounting bracket configured to attach to an electrical box that is mounted in a house and connected to electrical power via electrical wiring, the mounting bracket further configured to electrically connect to the electrical wiring;
a user interface module comprising a user interface module having a user input device configured to receive user input from a user;
a load control module in communication with the user interface module and configured to receive an indication of the user input from the user interface module, the user interface module configured to be removably attached to the load control module, the mounting bracket further configured to receive the load control module to provide the load control module with a powerline waveform from the electrical wiring, the load control module comprising:
receiving circuitry configured to receive coded messages over a home network using at least a first communication protocol and a second communication protocol;
transmitting circuitry configured to transmit the coded messages over the home network using the at least the first and second communication protocols, wherein the first communication protocol is propagated over a first communication medium and the second communication protocol is propagated over a second communication medium that is different from the first communication medium;
processing circuitry configured to receive the indication of the user input, to process the coded messages, and to provide control signals responsive to at least one of the indication of the user input and the coded messages; and
load control circuitry configured to change an operation of a device responsive to the control signals.

2. The in-wall modular assembly of claim 1 wherein the home network comprises a mesh network.

3. The in-wall modular assembly of claim 1 wherein the first communication protocol is powerline signaling and the second communication protocol is radio frequency (RF) signaling.

4. The in-wall modular assembly of claim 3 wherein the mesh network comprises a plurality of in-wall modular assemblies, each of the in-wall modular assemblies electrically coupled to the electrical wiring and configured to transmit and receive the coded messages synchronously over the mesh network using the powerline signaling and the RF signaling based on zero crossings of the powerline waveform.

5. The in-wall modular assembly of claim 4 wherein the powerline signaling comprises message data modulated onto a carrier signal and the data modulated carrier signal is added to the powerline waveform, and wherein the RF signaling comprises the message data modulated onto a RF signal.

6. The in-wall modular assembly of claim 5 wherein the carrier signal has a first frequency and the RF signal has a second frequency different from the first frequency.

7. The in-wall modular assembly of claim 6 wherein the first frequency is approximately 131.65 kHz.

8. The in-wall modular assembly of claim 6 wherein the second frequency is approximately 915 MHz.

9. The in-wall modular assembly of claim 1 wherein the user inputs are received independently of the home-control network.

10. The in-wall modular assembly of claim 1 wherein changing the operation of the device comprises controlling the powerline waveform to the device.

11. The in-wall modular assembly of claim 1 wherein the user input module has a configurable face.

12. The in-wall modular assembly of claim 11 wherein the user input device comprises one or more of a toggle switch, a rocker switch, a paddle switch, a key pad, a control knob, one or more LED's, and a speaker.

13. The in-wall modular assembly of claim 1 wherein the device is a lighting device and changing the operation comprises dimming the lighting device.

14. An in-home system to receive and transmit data and commands over a home network, the in-house system comprising a home network and a plurality of in-wall modular assemblies, each in-wall modular assembly comprising:
a mounting bracket configured to attach to an electrical box that is mounted in a house and connected to electrical power via electrical wiring, the mounting bracket further configured to electrically connect to the electrical wiring, a user interface module comprising a user interface module having a user input device configured to receive user input from a user, and a load control module in communication with the user interface module and configured to receive an indication of the user input from the user interface module, the user interface module configured to be removably attached to the load control module, the mounting bracket further configured to receive the load control module to provide the load control module with a powerline waveform from the electrical wiring, the load control module comprising:
receiving circuitry configured to receive coded messages over a home network using at least a first communication protocol and a second communication protocol, transmitting circuitry configured to transmit the coded messages over the home network using the at least the first and second communication protocols, wherein the first communication protocol is propagated over a first communication medium and the second communication protocol is propagated over a second communication medium that is different from the first communication medium, processing circuitry configured to receive the indication of the user input, to process the coded messages, and to provide control signals responsive to at least one of the indication of the user input and the coded messages, and load control circuitry configured to change an operation of a device responsive to the control signals.

15. The in-home system of claim 14 wherein the first communication protocol is powerline signaling that comprises message data modulated onto a carrier signal and the data modulated carrier signal is added to the powerline waveform, and wherein the second communication protocol is radio frequency signaling that comprises the message data modulated onto a RF signal.

16. The in-home system of claim 15 wherein the home network is a mesh network and wherein each of the in-wall modular assemblies is electrically coupled to the electrical wiring and configured to transmit and receive the coded messages synchronously over the mesh network using the powerline signaling and the RF signaling based on zero crossings of the powerline waveform.

17. A method to receive and transmit data and commands over a home network, the method comprising:
receiving with a mounting bracket, electrical power via electrical wiring from an electrical box that is mounted in a house;
receiving with a user interface module, user input from a user,
receiving with a load control module an indication of the user input from the user interface module, the user interface module configured to be removably attached to and in communication with the load control module;
receiving with the load control module a powerline waveform from the electrical wiring, the mounting bracket configured to be attached to and in communication with the load control module;
receiving with receiving circuitry of the load control module coded messages over a home network using at least a first communication protocol and a second communication protocol;
transmitting with transmitting circuitry of the load control module the coded messages over the home network using the at least the first and second communication protocols, wherein the first communication protocol is propagated over a first communication medium and the second communication protocol is propagated over a second communication medium that is different from the first communication medium;
receiving with processing circuitry of the load control module the indication of the user input, to process the coded messages; providing with the processing circuitry control signals responsive to at least one of the indication of the user input and the coded messages; and
changing with load control circuitry of the load control module an operation of a device responsive to the control signals.

18. The method of claim 17 wherein the first communication protocol is powerline signaling and the second communication protocol is radio frequency (RF) signaling.

19. The method of claim 18 wherein transmitting and receiving the coded messages occurs synchronously over the mesh network using the powerline signaling and the RF signaling based on zero crossings of the powerline waveform.

20. The method of claim 18 wherein the powerline signaling comprises message data modulated onto a carrier signal and the data modulated carrier signal is added to the powerline waveform, and wherein the RF signaling comprises the message data modulated onto a RF signal.
